(19) United States
(12) Patent Application Publication
(10) Pub. No.: US 2026/0126355 A1
(43) Pub. Date: May 7, 2026

(54) Device and Method for Analyte Isolation

(71) Applicant: Abbott Rapid Diagnostics International Unlimited Company, Dublin (IE)

(72) Inventors: Mi Jung Ji, Yongin-si (KR); Rohit Mishra, Dublin (IE); Ian O'Loughlin, Midleton (IE); Andrew Kirkham, Dublin (IE); Declan J. Fox, Dublin (IE); Do Yeong Koh, Seongnam-si (KR); Jin Woon Kim, Yongin-si (KR); Jun Yup Lee, Dublin (IE); Nicholas Collier, Cambridge (GB); Harry Turner, Cambridge (GB); Thomas Edward Parker, Cambridge (GB); Karen Yu, Cambridge (GB); Simon Thorne, Cambridge (GB)

(21) Appl. No.: 19/117,368

(22) PCT Filed: Oct. 6, 2023
(86) PCT No.: PCT/EP2023/077787

§ 371 Date: Mar. 31, 2025

Related U.S. Application Data
(60) Provisional application No. 63/378,656, filed on Oct. 6, 2022.
(60) Provisional application No. 63/491,238, filed on Mar. 20, 2023.
(60) Provisional application No. 63/471,663, filed on Jun. 7, 2023.

(51) Int. Cl. G01N 1/34; B01L 3/00

(52) U.S. Cl. CPC G01N 1/34; B01L 3/502761; B01L 2200/026; B01L 2200/0668; B01L 2200/16

(57) ABSTRACT

The disclosure provides devices for easy and quick isolation of target analytes in a point-of-care setting. In some aspects, the devices comprise a first compartment, a second compartment, and an adaptor. The adaptor comprises a removable/positionable magnet and, in a first position of the adaptor, the magnet immobilizes magnetic particles within the first compartment and in a second position of the adaptor, the magnet immobilizes magnetic particles within the second compartment. Moving the adaptor from the first position into the second position causes a sealed gas-phase transfer of magnetic particles from the first compartment to the second compartment. The magnetic particles bind to target analytes and, thus, moving the magnetic particles from the first compartment into the second compartment isolates the target analytes. The target analytes can be retrieved from the second compartment and analyzed. Methods of isolating target analytes using the devices disclosed herein are also provided.

WO

### CROSS-REFERENCE TO RELATED APPLICATIONS

This application claims priority to U.S. Provisional Application No. 63/378,656, filed Oct. 6, 2022, U.S. Provisional Application No. 63/491,238, filed Mar. 20, 2023, and U.S. Provisional Application No. 63/471,663, filed June 7, 20123, which applications are incorporated herein by reference in their entireties and for all purposes.

### INTRODUCTION

Analysis of a biological sample often involves determining the presence of a target analyte in the sample. The target analyte, if present, is isolated from the sample and analyzed using downstream applications, such as, amplification, immunoassay, and the like. Target analytes are isolated using approaches that include column-based isolation, reagent-based isolation, magnetic bead-based isolation, and other technologies. However, such approaches usually require complicated kits, instrumentation, and trained personnel leading to limited in-field application.

There exist a need in improving isolation of a target analyte from samples by developing relatively low-cost devices that can be used in easy-to-perform methods and provide sample preparation for intended detection methods by way of increased concentration of the target analyte or reduced noise via background removal.

### SUMMARY

The disclosure provides devices that allow easily and quickly isolating a target analyte from a sample. For example, the devices disclosed herein allow isolation of a target analyte in a point-of-care/point-of-need setting.

In some aspects, the devices comprise a first compartment, e.g., a sample compartment, and a second compartment, e.g., an elution compartment, and an adaptor. The adaptor is configured to engage with the first compartment and the second compartment. In certain embodiments, the adaptor comprises a magnet and, in a first position of the adaptor, the magnet immobilizes magnetic particles (that can capture target molecules of interest or remove unwanted molecules) within the first compartment. The adaptor is also configured to move from the first position into a second position and, in the second position of the adaptor, the magnet immobilizes magnetic particles within the second compartment. Moving the adaptor from the first position into the second position causes a sealed gas-phase transfer of magnetic particles from the first compartment, e.g., the sample compartment to the second compartment under the influence of the magnetic field.

In the second position of the adaptor, the magnet allows the magnetic particles to be released into the second compartment, for example, by moving the magnet from the second position to allow the magnetic particles to be released. Thus, the magnet is configured such that, in the capture position, the immobilized magnetic particles in the first compartment as well as the second compartment can interact with the reagents in the corresponding compartments. In the release positions, the magnet cannot interact with the reagents in the corresponding compartments. The adaptor may also be in a third position and, in the third position of the adaptor, the adaptor, including the magnet comprised in the adaptor, cannot interact with the reagents in either the first compartment or the second compartment.

Certain aspects of the present disclosure include an adaptor for isolating an analyte of interest from a sample. The isolation can be positive isolation or negative isolation as indicated below in more detail.

The adaptor is configured for simultaneous attachment to an opening of a vial and to a conical structure comprising an orifice. The adaptor includes a magnet positioned on a rotatable platform configured to position the magnet in a facing orientation to either the vial or the conical structure comprising an orifice. Methods for using the adaptor to isolate the analyte of interest are also provided.

Certain other aspects of the present disclosure include an adaptor configured for simultaneous attachment to a first compartment, e.g., a sample compartment and to a second compartment, e.g., an elution compartment. The adaptor includes a magnet positioned on a rotatable platform configured to position the magnet in a facing orientation to either the first compartment or the second compartment comprising an orifice. Methods for using the adaptor to isolate the analyte of interest are also provided.

Further aspects of the present disclosure include an adaptor configured for mutually exclusive engagement to a first compartment, e.g., a sample compartment and to a second compartment, e.g., an elution compartment. The adaptor includes a removable magnet that can be positioned in a capture position in a bead capture plunger of the adaptor. When the magnet is positioned in the capture position in the bead capture plunger of the adaptor engaged with the first compartment, the magnet captures magnetic particles that may be present in the first compartment. The adaptor can be disengaged from the sample compartment and then engaged to an elution compartment. When the adaptor is engaged to the elution compartment, the magnet may be moved from the capture position to a release position thereby releasing the magnetic particles into the elution compartment. Methods for using the adaptor to isolate the analyte of interest are also provided.

Even further aspects of the present disclosure provide an adaptor configured for engagement with a first compartment, e.g., a sample compartment, and to a second compartment, e.g., an elution compartment. The adaptor includes a removable magnet that can be positioned in a capture position in a bead capture plunger of the adaptor. When the magnet is positioned in the capture position in the bead capture plunger of the adaptor engaged with the first compartment, the magnet captures magnetic particles that may be present in the first compartment, the magnetic particles comprising a binding agent that specifically binds to a target analyte. The adaptor can be engaged with the second compartment, which is sealingly connected to the first compartment.

When the adaptor is engaged with the elution compartment, the magnet immobilizes the magnets within the elution compartment and the elution reagents in the elution compartment cause dissociation of the captured analytes from the binding agent and, hence, from the magnetic particles. The released analytes can then be obtained from the second compartment. Methods for using the adaptor to isolate the analyte of interest are also provided.

Certain aspects of the disclosure also provide a lid configured for simultaneous engagement to a first compartment, e.g., a sample compartment, and to a second compartment, e.g., an elution compartment. The lid includes an adaptor comprising a removable magnet that can be positioned in a first position, where the magnet engages with reagents in the first compartment. The magnet is movable from the first position into a second position, where the magnet engages with reagents in the second compartment. In the first position, the magnet captures magnetic particles from the first compartment. In the second position, the magnet presents the magnetic particles into the second compartment and the reagents in the second compartment may cause the analytes attached to the magnetic particles, for example, through conjugated binding agents, to be released into the second compartment.

In certain such embodiments, the adaptor is mounted on a rotating lid such that the adaptor can be moved between the first position and the second position by turning the rotating roof of the lid.

In some embodiments, the adaptor is mounted on a sliding lid such that the adaptor can be moved from the first position to the second position by linearly sliding the sliding lid in a first direction and the adaptor can be moved from the second position to the first position by linearly sliding the sliding lid in a second direction, which is opposite of the first direction.

In further embodiments, the adaptor is a piston mounted on the lid such that the adaptor can be moved between the first position and the second position by moving the piston.

Methods for using the adaptors described herein to isolate the analyte of interest are also provided.

### BRIEF DESCRIPTION OF THE FIGURES

FIG. 1 depicts an exploded view of an adaptor 100 according to one embodiment. A tube 101 and a dropper 102 are also depicted.

FIG. 2 depicts an exploded view of an adaptor 200 according to one embodiment. A tube 1 and a dropper 2 are also depicted.

FIG. 3 illustrates exemplary components for isolation and detection of a target analyte.

FIG. 4 depicts an exemplary method for isolation and detection of an analyte of interest according to one embodiment of the present disclosure.

FIG. 5 depicts an exemplary method for isolation and detection of an analyte of interest according to one embodiment of the present disclosure.

FIG. 6 depicts an exemplary analyte isolation device.

FIG. 7 depicts an exploded view of the analyte isolation device of FIG. 6.

FIGS. 8A-8E depict operation of the analyte isolation devices described in FIGS. 6-7.

FIG. 9 depicts an exemplary analyte isolation device.

FIG. 10 depicts an exploded view of the analyte isolation device of FIG. 9.

FIG. 11 depicts an exemplary analyte isolation device.

FIG. 12 depicts an exploded view of the analyte isolation device of FIG. 12.

FIGS. 13A-13C depict operation of the analyte isolation devices described in FIGS. 11-12.

FIG. 14 depicts an exemplary analyte isolation device as well as exploded view of a cross section of the analyte isolation device.

FIG. 15 depicts an exemplary analyte isolation device as well as exploded view of a cross section of the analyte isolation device.

FIG. 16 depicts an exemplary analyte isolation device as well as exploded view of a cross section of the analyte isolation device.

### DETAILED DESCRIPTION

Aspects of the present disclosure include an adaptor for isolating an analyte of interest from a sample. The adaptor is configured for simultaneous attachment to an opening of a vial and to a conical structure comprising an orifice. The adaptor includes a magnet positioned on a rotatable platform configured to position the magnet in a facing orientation to either the vial or the conical structure comprising an orifice. Methods for using the adaptor to isolate the analyte of interest are also provided.

Before the present devices and methods are described in greater detail, it is to be understood that the present disclosure is not limited to particular embodiments described, as such may, of course, vary. It is also to be understood that the terminology used herein is for the purpose of describing particular embodiments only, and is not intended to be limiting.

Where a range of values is provided, it is understood that each intervening value, to the tenth of the unit of the lower limit unless the context clearly dictates otherwise, between the upper and lower limit of that range and any other stated or intervening value in that stated range, is encompassed within the devices and methods. The upper and lower limits of these smaller ranges may independently be included in the smaller ranges and are also encompassed within the devices and methods, subject to any specifically excluded limit in the stated range. Where the stated range includes one or both of the limits, ranges excluding either or both of those included limits are also included in the devices and methods.

Certain ranges are presented herein with numerical values being preceded by the term “about.” The term “about” is used herein to provide literal support for the exact number that it precedes, as well as a number that is near to or approximately the number that the term precedes. In determining whether a number is near to or approximately a specifically recited number, the near or approximating un-recited number may be a number which, in the context in which it is presented, provides the substantial equivalent of the specifically recited number.

Unless defined otherwise, all technical and scientific terms used herein have the same meaning as commonly understood by one of ordinary skill in the art to which this disclosure belongs. Although any methods and materials similar or equivalent to those described herein can also be used in the practice or testing of the present devices and methods, representative devices and methods are now described.

The present disclosure may be understood more readily by reference to the following detailed description of desired embodiments and the examples included therein. In the following specification and the claims which follow, reference will be made to a number of terms which shall be defined to have the following meanings.

Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

The term “comprising” is used herein as requiring the presence of the named component and allowing the presence of other components. The term “comprising” should be construed to include the term “consisting essentially of” and “consisting of.” The “consisting essentially of” allows the presence of the named component(s), along with other component which do not change the function/structure of the named component(s). The “consisting of” allows the presence of the named component(s), along with any adhesives or other bonding means for attaching the listed component(s).

Numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently combinable (for example, the range of “from 2 grams to 10 grams” is inclusive of the endpoints, 2 grams and 10 grams, and all the intermediate values). The endpoints of the ranges and any values disclosed herein are not limited to the precise range or value; they are sufficiently imprecise to include values approximating these ranges and/or values.

The modifier “about” used in connection with a quantity is inclusive of the stated value and has the meaning dictated by the context. When used in the context of a range, the modifier “about” should also be considered as disclosing the range defined by the absolute values of the two endpoints. For example, the range of from about “2 to about 10” also discloses the range “from 2 to 10.” The term “about” may refer to plus or minus 10% of the indicated number. For example, “about 10%” may indicate a range of 9% to 11%, and “about 1” may mean from 0.9-1.1.

It should be noted that many of the terms used herein are relative terms. For example, the terms “upper” and “lower” are relative to each other in location, i.e., an upper component is located at a higher elevation than a lower component in a given orientation, but these terms can change if the component is flipped. The terms “inlet” and “outlet” are relative to a fluid flowing through them with respect to a given structure, e.g., a fluid flows through the inlet into the structure and flows through the outlet out of the structure.

The terms “horizontal” and “vertical” are used to indicate direction relative to an absolute reference, i.e., ground level. However, these terms should not be construed to require structures to be absolutely parallel or absolutely perpendicular to each other. For example, a first vertical structure and a second vertical structure are not necessarily parallel to each other. The terms “top” and “bottom” are used to refer to surfaces where the top is always higher than the bottom relative to an absolute reference, i.e., the surface of the earth. The terms “upwards” and “downwards” are also relative to an absolute reference; upwards is always against the gravity of the earth while downwards is always towards the gravity of the earth.

The term “parallel” should be construed in its lay sense of two surfaces that maintain a generally constant distance between them, and not in the strict mathematical sense that such surfaces will never intersect when extended to infinity.

Isolating an analyte refers to removing away the analyte from additional molecules present with the analyte, for example, other components in a biological sample comprising the analyte.

All publications and patents cited in this specification are herein incorporated by reference as if each individual publication or patent were specifically and individually indicated to be incorporated by reference and are incorporated herein by reference to disclose and describe the methods and/or materials in connection with which the publications are cited. The citation of any publication is for its disclosure prior to the filing date and should not be construed as an admission that the present invention is not entitled to antedate such publication by virtue of prior invention. Further, the dates of publication provided may be different from the actual publication dates which may need to be independently confirmed.

It is noted that, as used herein and in the appended claims, the singular forms “a”, “an”, and “the” include plural referents unless the context clearly dictates otherwise. It is further noted that the claims may be drafted to exclude any optional element. As such, this statement is intended to serve as antecedent basis for use of such exclusive terminology as “solely,” “only” and the like in connection with the recitation of claim elements or use of a “negative” limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present devices and methods. Any recited method can be carried out in the order of events recited or in any other order which is logically possible.

### Devices

As summarized above, aspects of the present disclosure include an adaptor for isolating an analyte of interest from a sample. In certain aspects, the devices comprise a first compartment, e.g., a sample compartment, and a second compartment, e.g., an elution compartment, and an adaptor. The adaptor is configured to engage with the first compartment and the second compartment. In certain embodiments, the adaptor comprises a magnet and, in a first position of the adaptor, the magnet immobilizes magnetic particles within the first compartment. The adaptor is also configured to move from the first position into a second position and, in the second position of the adaptor, the magnet immobilizes magnetic particles within the second compartment. Moving the adaptor from the first position into the second position causes a sealed gas-phase transfer of magnetic particles from the first compartment, e.g., the sample compartment, to the second compartment, e.g., an elution compartment, under the influence of the magnetic field.

In the second position of the adaptor, the magnet allows the magnetic particles to be released into the second compartment, for example, by moving the magnet from the second position to allow the magnetic particles to be released. Thus, the magnet is configured such that, in the capture position, the magnetic immobilizes magnetic particles in the first compartment or the second compartment. In the release positions, the magnet cannot interact with the reagents in the corresponding compartments. The adaptor may also be in a third position and, in the third position of the adaptor, the adaptor, including the magnet comprised in the adaptor, cannot interact with the reagents in either the first compartment or the second compartment.

In some cases, the device comprises more than two compartments. Such embodiments allows for additional steps to be incorporated into the design if the assay/sample processing requires that. For example, the beads may be washed in between the two compartments using a stored buffer in a middle compartment.

In certain aspects, an adaptor comprises a substantially cylindrical body comprising a first open end opposite a second open end. The first open end may be configured to sealingly attach to an opening of a vial. The second open end may be configured to sealingly attach to an opening of a conical structure comprising an orifice. The adaptor may further comprise an opening on a surface of the cylindrical body, where the opening is located substantially medially between the first and second open ends of the cylindrical body.

The adaptor may further include a platform sized to slidably fit through the opening in the surface of the cylindrical structure. The platform may include a first region that is configured for placement inside the cylindrical structure and a second region that remains positioned outside the cylindrical structure upon sliding of the platform into the cylindrical structure through the opening. The platform is configured to hold a magnet in place during rotation of the platform.

In some embodiments, the adaptor further includes a cylindrical cuff that slidably fits through the opening on the surface of the cylindrical body. The cylindrical cuff includes at least one opening sized to slidably fit the first region of the platform, where the at least one opening is positioned on either a first end or a second end of the cylindrical cuff. The cylindrical cuff further includes an opening on a surface thereof. The opening on a surface of the cylindrical cuff may be located substantially medially between the first and second ends of the cylindrical cuff.

In a first embodiment, the second region of the platform may include a means for rotating the platform by rotating the cylindrical cuff. In a second embodiment, the cylindrical cuff may include a means for rotating the platform by rotating the cylindrical cuff. In both embodiments, the platform and the cylindrical cuff are engaged such that they rotate as one unit. The cylindrical cuff is sized to occupy the interior of the cylindrical body and occlude the interior such that a fluid may not flow between the two ends directly.

In certain embodiments, the means for rotating the platform may include a lever that can be twisted to rotate the platform. In certain embodiments, the lever may include a marking to denote the orientation of the platform. In a first orientation, the adaptor may include the cylindrical cuff in the cylindrical body such that the opening in the surface of the cylindrical cuff faces an interior surface of the cylindrical body, where the surface closes the opening. In this orientation, a fluid may not enter the cylindrical cuff through the opening. In certain embodiments, the marking to denote the orientation of the platform may be an arrow. The arrow may be in an orientation parallel to the ground to indicate the first orientation of the cylindrical cuff. This orientation can be used to close the opening of a vial or tube comprising a sample and magnetic particles for binding to an analyte that may be present in the sample. In a second orientation, the adaptor may include the cylindrical cuff in the cylindrical body such that the opening in the surface of the cylindrical cuff is aligned with the opening of tube sealingly engaged with the adaptor. In this first orientation, a sample present in the vial can be brought in contact with the magnet positioned in the platform positioned in the cylindrical cuff. In this first orientation, the lever may be in a second position. A marking on the lever may indicate that the cylindrical cuff is in a second position. For example, the arrow may point downwards.

After the sample had been brought in contact with the magnet and magnetic particles present in the sample have attached to the magnet, the means for rotating the platform, for example the lever, may be moved (e.g., flipped or twisted) to a third orientation. In this third orientation, the opening in the surface of the cylindrical cuff is aligned with the opening in a conical structure comprising an orifice. In this third orientation, a solution present in the conical structure comprising an orifice is in contact with the magnet.

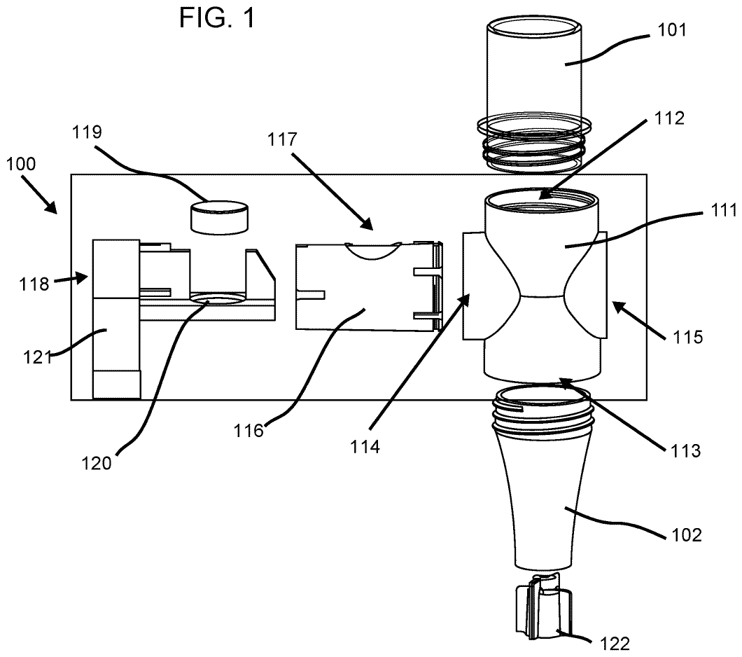

Exemplary adaptors are depicted in FIGS. 1, 2, and 6.

FIG. 1 depicts an adaptor 100 having a substantially cylindrical body 111 and having a first opening 112 opposite a second opening 113. The interior of the cylindrical body 111 is substantially hollow such that the first and second openings are in fluid communication. In some cases, this fluidic communication is only opened/closed when controlled by an insert, e.g., a cylindrical cuff 116.

A surface of the cylindrical body 111 includes at least one opening 114. In some embodiments, the surface of the cylindrical body 111 may include an additional opening 15 diametrically opposite the opening 114. The cylindrical cuff 116 is configured to slide through the opening 114 and fit inside the cylindrical body 111. In certain embodiments, the cylindrical cuff 116 is supported by both opening 114 and opening 115. The cylindrical cuff 16 includes an opening 117 on a surface there of. The opening 117 is located substantially medially with respect to the ends of the cylindrical cuff 116. A platform 118 configured for holding a magnet 119 is depicted. The platform 118 includes a first region 120 that fits inside the cylindrical cuff 116 and is oriented such that the magnet is in a facing orientation with the opening 117. The platform 118 includes a second region 121 that is configured for being positioned outside the cylindrical cuff 116. The second region 121 provides a means for rotating the platform 118 and the cylindrical cuff 116. The cylindrical cuff 116 and the platform 118 are sized to engage such that they move as a single unit.

Also depicted in FIG. 1 is a tube 101 and a dropper 102. These components may not be part of the adaptor of the present disclosure but may be included in a kit comprising the adaptor. The tube 101 may be any tube suitable for housing a sample. The open end of the tube and the first opening of the adaptor are configured for sealingly engage with each other. For example, the open end of the tube and the first opening of the adaptor may include means for mating the open end and the first opening, such as, snap fit configuration, twist-cap configuration, threaded screw-on configuration and the like. Similarly, the dropper 102 may include an opening that sealingly attaches to the second opening of the cylindrical body. The dropper 102 may include a solution, e.g., an elution buffer. The dropper may also include an orifice and a compressible body. The orifice may dispense a solution containing the target analyte present in the dropper 102 upon application of compression to the dropper body. The orifice may include a cap 122 that can be removed before dispensing.

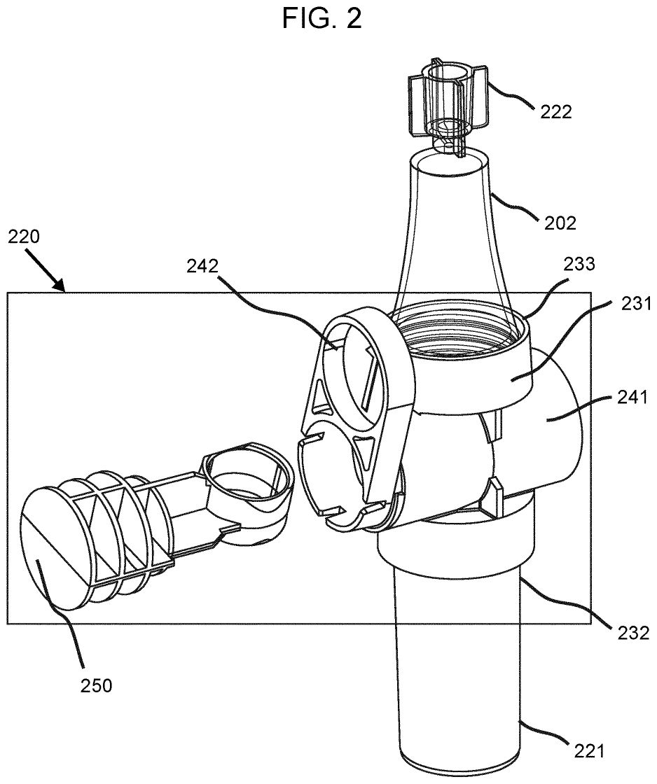

FIG. 2 depicts an embodiment of an adaptor of the present disclosure. The adaptor 200 having a substantially a cylindrical body 231 and having a first opening 232 opposite a second opening 233. The first opening 232 is configured for attachment to an opening of a tube 221. The second opening 233 is configured for attachment to an opening of a conical structure with an orifice, such as the dropper 202, where the opening of the conical structure is opposite to the orifice. While depicted in FIG. 2, the tube 221 and dropper 202 may not be a component of the adaptor.

As visible in FIG. 2, the cylindrical body 231 includes a cylindrical cuff 241 positioned at a radial axis of the cylindrical body 231. The cylindrical cuff 241 is rotatable with respect to the cylindrical body 231. The cylindrical cuff 241 includes a means, e.g., a lever 242, for rotating the cylindrical cuff 241. Also depicted in FIG. 2 is a platform 250 configured to hold a magnet. The platform 250 is sized to fit within the cylindrical cuff 241 such that the cylindrical cuff 241 and the platform rotate as one unit upon actuation of lever 242. The cylindrical cuff 241 includes an opening in a surface thereof which opening is located substantially medially between the two ends of the cylindrical cuff 241. The opening and the magnet are oriented such that the magnet substantially faces the opening.

As noted for FIG. 2, the lever 242 can include a marking for indicating an orientation of the cylindrical cuff 241 and the platform 250.

In certain embodiments, the adaptor may be preassembled such that the platform with an immobilized magnet is positioned within cylindrical cuff 116, 241. The adaptor may be preassembled such that the magnet and the opening in the cylindrical cuff are oriented in a manner that allows liquid to flow through the opening in the cylindrical cuff and contact the magnet. The means for rotating the platform and the cylindrical cuff may include a marking indicating the orientation of the opening in the cylindrical cuff with respect the first and second openings in the cylindrical body. In some embodiments, the first and second openings in the cylindrical body of the adaptor may be covered with caps. The caps may be removed prior to attaching the adaptor to a tube or a dropper.

Additional marking for indicating the orientation of the cylindrical cuff may guide a user to the opening of the adaptor that can be attached to a tube.

The tube that engages with the adaptor may be any suitable tube, such as, a vial that includes a solution for processing a sample. The solution may be a lysis solution, e.g., a lysis buffer.

The dropper may be any suitable, substantially conical structure that includes an opening for attaching to the adaptor and an orifice for dispensing a liquid. The dropper may include a cap that covers the opening prior to attachment to the adaptor. The dropper may also include a cap for covering the orifice. The dropper may include a solution for eluting an analyte bound to paramagnetic particles (PMPs) immobilized on the magnet.

A sample may be mixed with lysis buffer. Any suitable lysis buffer such as those used for rupturing a cell or a virus may be used. In certain instances, the lysis buffer may include a chaotropic agent such as guanidine hydrochloride. An analyte of interest may be eluted from the PMPs using an elution buffer.

In some instances, a paramagnetic particles (PMPs) or capture beads, e.g., beads coated with an agent that binds to an analyte of interest may be added to the sample. The agent may be an oligonucleotide, a peptide, or a protein or other target analyte.

In some instances, the lysis buffer can be formulated to release nucleic acid and/or proteins from a broad spectrum of samples, such as tissue samples, cells, viruses, or body fluid samples. The lysis buffer can also be designed to lyse all types of pathogens, such as viruses, bacteria, fungi, and protozoan pathogens.

In some instances, the analyte of interest may be an analyte associated with a pathogen or an infection such as tuberculosis. In some instances, the analyte of interest may be LAM (lipoarabinomannan) antigen (LAM). In some instances, the sample may be a body fluid sample, e.g., urine, saliva or blood or parts thereof. In some instances, the PMPs may include anti-LAM antibodies.

The elution buffer may be suitable for facilitating detachment of a target analyte, e.g., a nucleic acid or protein from the PMPs. For example, the elution buffer may include a high concentration of a salt, e.g., sodium chloride or an alkaline agent, e.g., sodium hydroxide or a low ionic strength solution such as a Tris-EDTA buffer (10 mm Tris-HCl, 0.1 mm EDTA (pH 8.0) or nuclease-free water.

As used herein, the term cylinder or cylindrical refers to a substantially cylindrical structure where the sides or walls are substantially parallel, and the cross-section is substantially circular or oval. By substantially, it is meant that there may be insignificant deviation from the stated shape. Cylinder and cylindrical encompasses a hollow cylinder, a solid cylinder, and a cylinder having a partially filled interior.

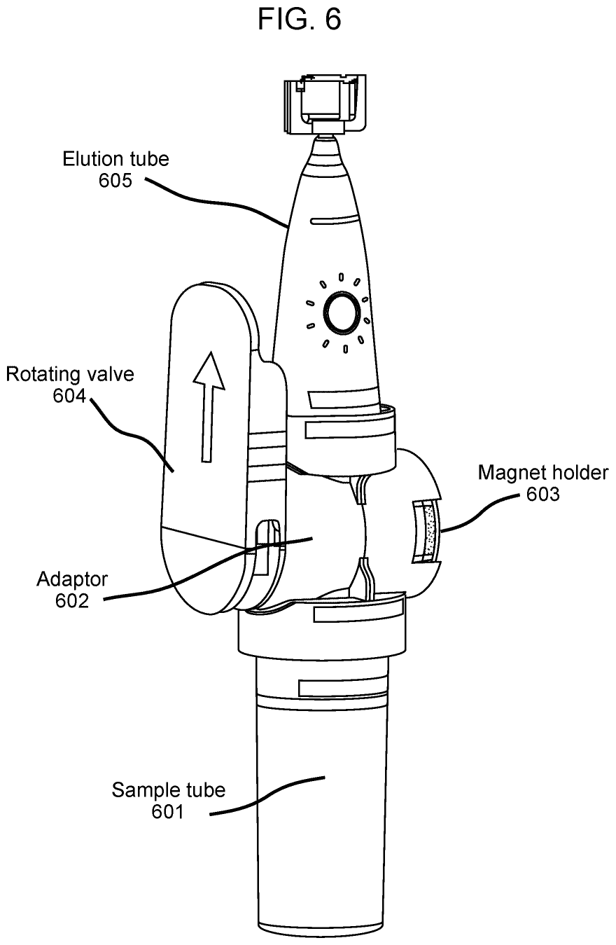

FIG. 6 depicts an adaptor 602 having a substantially cylindrical body and having a first opening towards the bottom opposite to a second opening towards the top. The interior of the cylindrical body is substantially hollow such that the first and second openings are in fluid communication.

A surface of the cylindrical body includes at least a first opening in a horizontal direction. In some embodiments, the surface of the cylindrical body may include an additional opening diametrically opposite the first opening. A cylindrical cuff may be included in the cylindrical body. The cylindrical cuff is described above and such discussion is also applicable here. The adaptor 602 further comprises a magnet holder 603 which provides the magnet that engages with the reagents in the sample tube 601 and the elution tube 605.

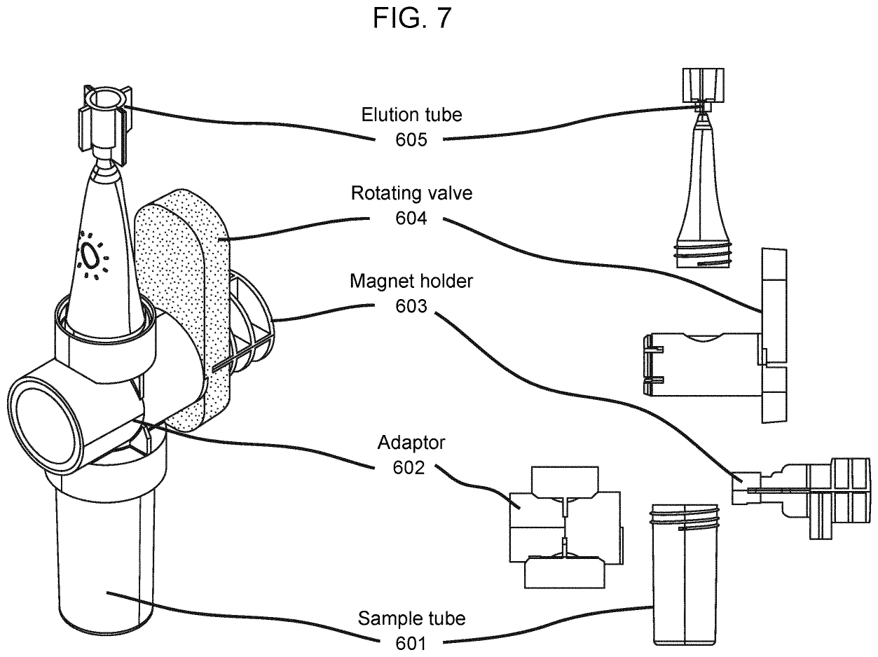

Also depicted in FIGS. 6 and 7 are a sample tube 601 and an elution tube 605. These components may not be part of the adaptor of the present disclosure but may be included in a kit comprising the adaptor. The sample tube may be any tube suitable for housing a sample. The open end of the sample tube and the first opening of the adaptor are configured for sealingly engaging with each other. For example, the open end of the sample tube and the first opening of the adaptor may include means for mating the open end and the first opening, such as, snap fit configuration, twist-cap configuration, threaded screw-on configuration and the like. Similarly, the elution tube 605 may include an opening that sealingly attaches to the second opening of the cylindrical body. The elution tube may include a solution, e.g., an elution buffer. The elution tube may also include an orifice and a compressible body. The elution tube may be configured to dispense a solution that would elute the target analyte from the magnetic particles. The elution tube may also include a cap that can be removed to dispense the elution buffer containing the target analyte.

As described in FIGS. 6 and 7, the adaptor 602 has a substantially cylindrical body and has a first opening opposite a second opening. The first opening is configured for attachment to an opening of the sample tube 601. The second opening is configured for attachment to an opening of the elution tube 605. While depicted in FIGS. 6 and 7 as such, the sample tube and the elution tube may not be a component of the adaptor.

As visible in FIGS. 6 and 7, the cylindrical body includes a cylindrical cuff positioned at a radial axis of the cylindrical body. The cylindrical cuff is rotatable with respect to the cylindrical body. The cylindrical cuff includes a means, e.g., rotating valve 604, for rotating the cylindrical cuff. Also depicted in FIGS. 6 and 7 is a magnet holder 603 configured to hold the magnet. The magnet holder is sized to fit within the cylindrical cuff such that the cylindrical cuff and the platform rotate as one unit upon actuation of the rotating valve 604. The cylindrical cuff includes an opening in a surface thereof which opening is located substantially medially between the two ends of the cylindrical cuff. The opening and the magnet are oriented such that the magnet substantially faces the opening.

As noted in FIGS. 6 and 7, the rotating valve 604 can include a marking, such as an arrow, for indicating the orientation of the cylindrical cuff and the platform. For example, when the arrow on the rotating valve points towards the sample tube, the adaptor, e.g., the magnet inside the adaptor engages with the reagents in the sample tube. Alternatively, when the arrow points towards the elution tube, the adaptor, e.g., the magnet inside the adaptor, engages with the reagents in the elution tube. When the arrow of the rotating valve does not point to either the sample tube or the elution tube, the adaptor may not engage with either of the tubes.

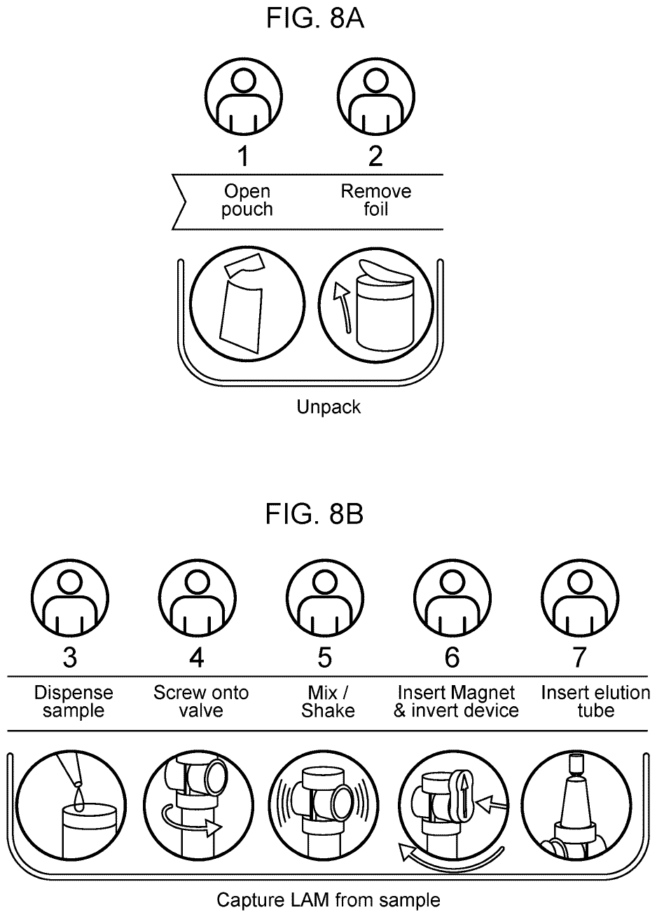

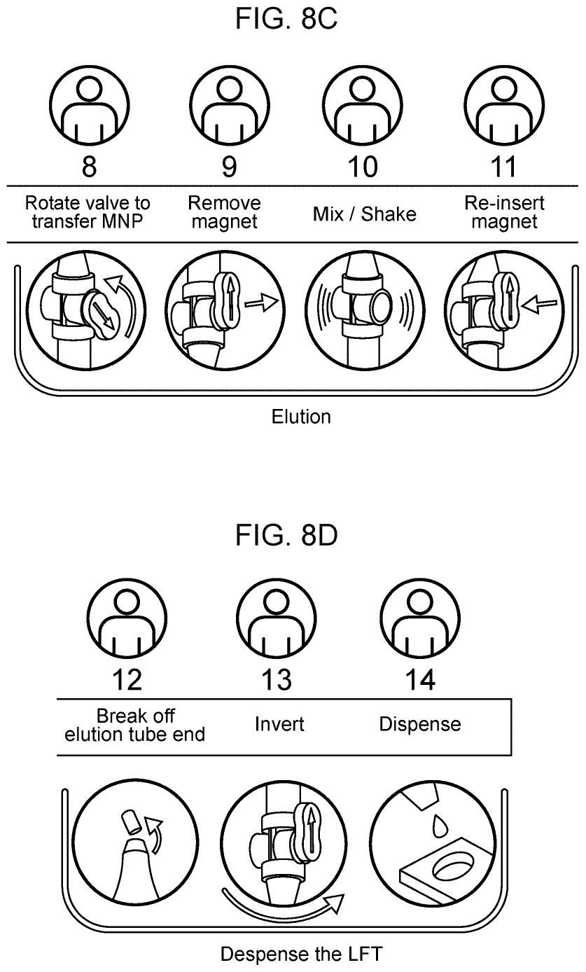

Exemplary operation of the devices of FIGS. 1-2 and 6-7 is provided in FIGS. 8A-8E.

FIG. 8A, steps 1 and 2, show that the device can be provided to a user in a packaging, such as a sealed pouch, for example, a sterile sealed pouch. The packaging may contain separate components, for example, those shown in FIG. 2 or FIG. 7, right panel, or preassembled device as shown in FIGS. 1, 6, or FIG. 7, left panel.

Once removed from the pouch, a user may add a sample to the sample tube (FIG. 8B, step 3). The sample tube, as packaged, may contain sample processing buffer or a sample processing buffer can be added by a user. Moreover, a sample processing buffer may contain magnetic particles comprising conjugated binding agent or such magnetic particles may be separately added.

Once a sample and sample processing buffer are in the sample tube, a user can then and screw the valve on top of the sample tube (FIG. 8B, step 4). The sample tube may be shaken to facilitate sample processing, for example, lysis of the sample components, such as cells as well as binding of the target analyte to the binding agents conjugated to magnetic particles (FIG. 8B, step 5).

Any suitable magnetic particles conjugated to binding agents can be used and many such examples are well-known in the art. The binding agent can be a binding protein, an aptamer, an antibody or a binding fragment thereof, or a protein binding partner of the target analyte. Many such binding agents are well-known in the art and use of any such agents is within the purview of the invention.

Once sample processing is completed, for example, after shaking and/or incubation for a period of time, a user may then insert the magnet and invert the device so that the sample is on the top of the valve (FIG. 8B, step 6). Elution tube can then be attached to the valve ((FIG. 8B, step 7).

The user can then turn the valve so that the magnet is engages with the reagents in the sample tube and binds the magnetic particles from the sample tube. The user can then turn the valve to cause a sealed gas-phase transfer of magnetic particles from the sample tube to the elution tube (FIG. 8C, step 8).

The magnet can then be removed thereby releasing the magnetic particles into the elution tube (FIG. 8C, step 9). The elution tube can then be mixed or shaken to allow elution buffer to cause the target analyte to be released from the binding agents. Many conditions in an elution buffer can cause the release of the target analyte. Such conditions include high or low salt concentrations, high or low pH, high concentration of another ligand that competes with the binding agent, etc. Many such options are known in the art and use of such embodiments is within the purview of the disclosure.

The magnetic particles can then be recaptured by re-inserting the magnet into the valve (FIG. 8C, step 11).

Once the magnetic particles are attached to the magnet, the elution tube may be punctured, for example, by breaking off a tip so designed (FIG. 8D, steps 12-13). The eluted target analyte can then be introduced into an analytical device, such as a lateral flow assay device for assaying the eluted target analyte.

After the results of the assay are observed, the device of the disclosure as well as the assay device can be disposed (FIG. 8E, steps 15-16).

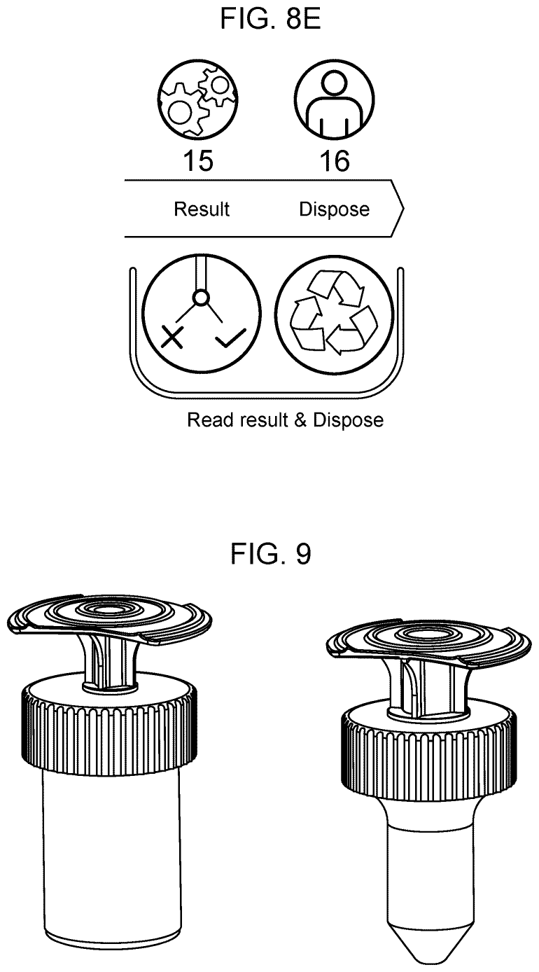

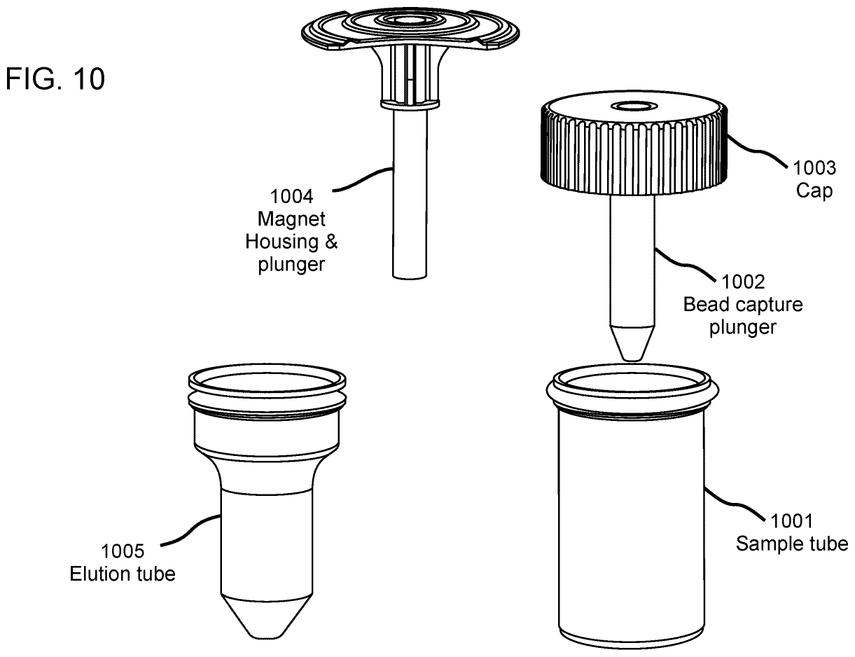

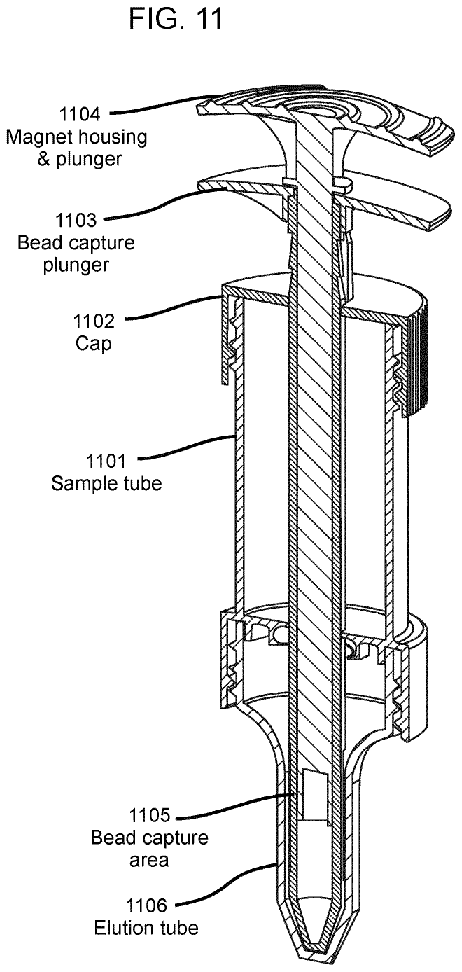

FIGS. 9-10 describe further aspects of the present disclosure. In such aspects, an adaptor is configured for mutually exclusively engaging with a first compartment, e.g., a sample compartment and a second compartment, e.g., an elution compartment. The adaptor may engage with the first and/or the second compartments by any suitable configuration, such as snap fit configuration, twist-cap configuration, threaded screw-on configuration and the like.

As shown in FIG. 10, in some cases, the adaptor comprises a cap 1003 and a bead capture plunger 1002. The bead capture plunger 1002 is a hollow elongated structure that is inserted into a first or a second compartment when the cap 1003 is placed on the first or second compartment. The hollow region of the bead capture plunger 1002, for example an elongated tube like region, provides appropriate space for engaging with a magnet of a magnetic housing and plunger 1004.

In the operation of the device of FIG. 10, a user can add to the sample tube 1001 a sample, sample processing buffer, and magnetic particles comprising conjugated binding agents that specifically bind to the target analyte. The user can then place the cap 1003 on to the sample tube 1001. The bead capture plunger contacts the reagents within the sample tube 1001. A user can shake the contents of the sample tube and can incubate the reagents for appropriate time under appropriate conditions to cause the target agent to bind the binding agent and, hence, the magnetic particles.

The user can then insert the magnet housing and plunger 1004 into the cap 1003 so that the magnetic plunger is positioned inside the bead capture plunger 1002. The magnet causes the magnetic particles from the sample tube to attach to the bead capture plunger 1002. Thus, the magnet captures the target analytes.

A user can then remove the cap thereby removing the magnetic particles comprising the target analyte and then place the cap onto the elution tube 1005 containing an elution buffer. This constitutes a sealed gas-phase transfer of magnetic particles from the sample tube to the elution tube.

The magnet housing and plunger 1004 can then be removed thereby releasing the magnetic particles into the elution tube. The elution tube can then be mixed or shaken to allow elution buffer to cause the target analyte to be released from the binding agents. As discussed above, many options for causing the release of target analytes from the binding agents are known in the art and use of such embodiments is within the purview of the disclosure.

After sufficient processing is performed to allow release of the target analyte from the magnetic particles, the magnetic particles can be recaptured by re-inserting the magnet housing and plunger 1004 into the elution tube. The cap 1003 containing the magnet housing and plunger can then be removed to remove the magnetic particles away from the elution buffer.

The elution buffer remaining in the elution buffer contains the target analyte free of magnetic particles. The elution buffer can then be analyzed for the target analyte, for example, using a lateral flow assay device.

In a certain aspect, as depicted in FIG. 11, a sample tube and an elution tube are sealingly connected to each other. Such devices work similar to the devices described in FIG. 10, except that a user need not transfer the cap 1003 of the sample tube to the elution tube.

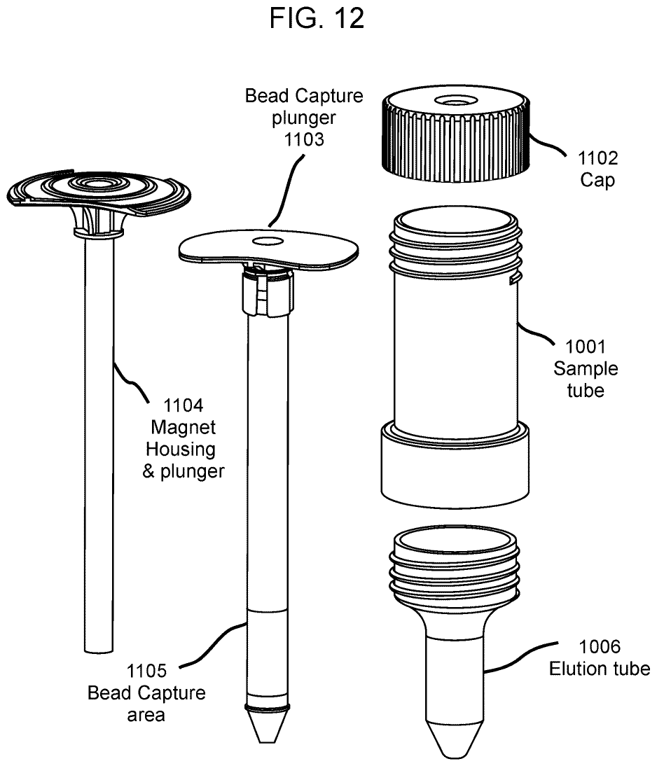

As shown in FIGS. 11-12, in certain embodiments, the devices disclosed herein comprise a sample tube 1101, which is cylindrical in shape. A bead capture plunger 1103 passes through the center of the cylindrical sample tube 1101. The bead capture plunger also provides a housing for magnet housing and plunger 1104.

The sample tube 1101 is sealingly connected to the elution tube 1106. The term “sealingly connected” as used herein refers to a connection that prevents liquid leak. Thus, a second compartment sealingly connected to the first compartment indicates that a liquid does not leak from the first compartment into the second compartment.

The magnet housing and plunger is configured to engage with the reagents in the sample tube and capture magnetic particles therein. The magnet housing and plunger is also configured to pierceably move from sample tube 1101 into the elution tube 1106 and thus cause sealed gas-phase transfer of magnetic particles from the sample tube to the elution tube 1106.

Once in the elution tube 1106, an elution buffer can allow elution of the target analyte from the magnetic particles. The eluted target analyte can be retrieved from the elution tube 1106.

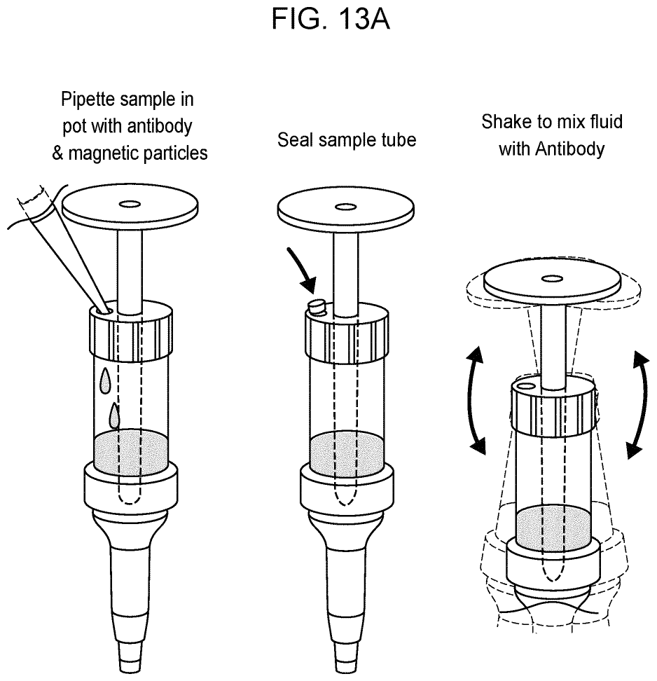

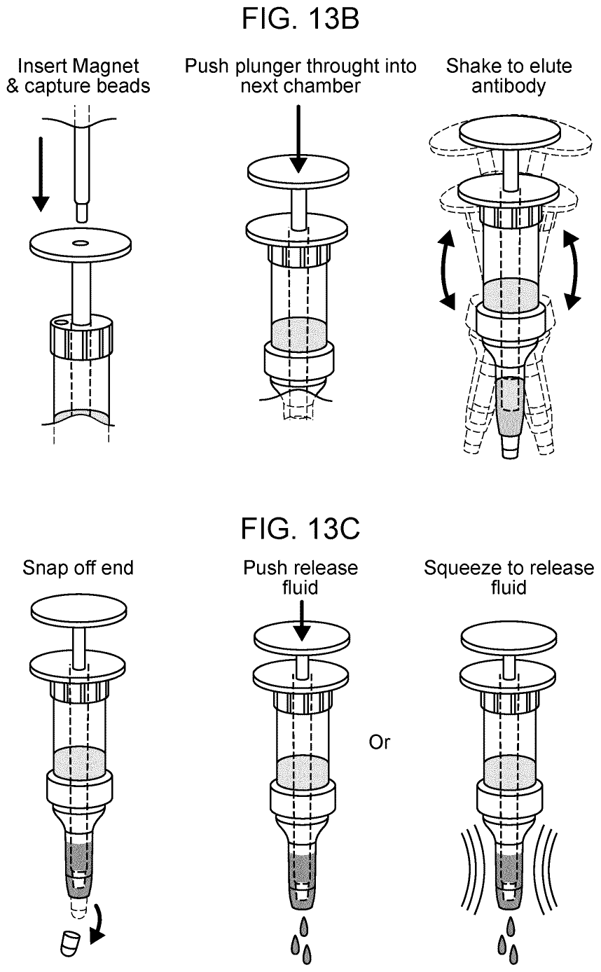

Exemplary operation of the devices of FIGS. 11 and 12 is provided in FIGS. 13A to 13C. As shown in FIG. 13A, left illustration, a user can add sample in the sample tube 1001 along with magnetic particles comprising conjugated a binding agent for target analytes, such as antibody. The sample tube 1101 can be sealed (FIG. 13A, middle illustration) and shaken (FIG. 13A, right illustration) to mix the sample with magnetic particles comprising the binding agents for the target analyte.

After the sample is treated appropriately to allow binding of the target analytes to the magnetic particles, the magnet housing and plunger 1104 is inserted into the bead capture plunger 1103 to capture magnetic particles from the sample tube (FIG. 13B, left illustration). The bead capture plunger comprises a bead capture area and the magnet causes the magnetic particles from the sample in the bead capture area.

After the magnetic particles are captured, the magnet housing and plunger 1104 can be pushed through into the elution tube 1106. The sample tube, the elution tube, and the magnetic housing and plunger are configured so that the magnetic housing and plunger can pierce through the sample tube into the elution tube thereby carrying only the magnetic particles and not allowing any other reagents from the sample tube to leak into the elution tube.

Once into the elution tube, the magnetic particles come in contact with an elution buffer. Elution of the target analyte can be facilitated by shaking or mixing of the device, as shown in FIG. 13B, right illustration.

Finally, the removable bottom of the elution tube can be removed as shown in FIG. 13C, left illustration. The elution buffer containing the target analyte may be removed by further pushing the magnetic housing and plunger (FIG. 13C, middle illustration) or squeezing the elution tube (FIG. 13C, right illustration).

Even further aspects of the disclosure provide devices for isolating target analytes comprising a lid that simultaneously engages with a first compartment, e.g., a sample compartment, and to a second compartment, e.g., an elution compartment. The lid includes an adaptor comprising a removable magnet that can be positioned in a first position, where the magnet engages with reagents in the first compartment. The magnet is movable from the first position into a second position, where the magnet engages with reagents in the second compartment. In the first position, the magnet captures magnetic particles from the first compartment. In the second position, the magnet presents the magnetic particles into the second compartment and the reagents in the second compartment may cause the analytes attached to the magnetic particles, for example, through conjugated binding agents, to be released into the second compartment.

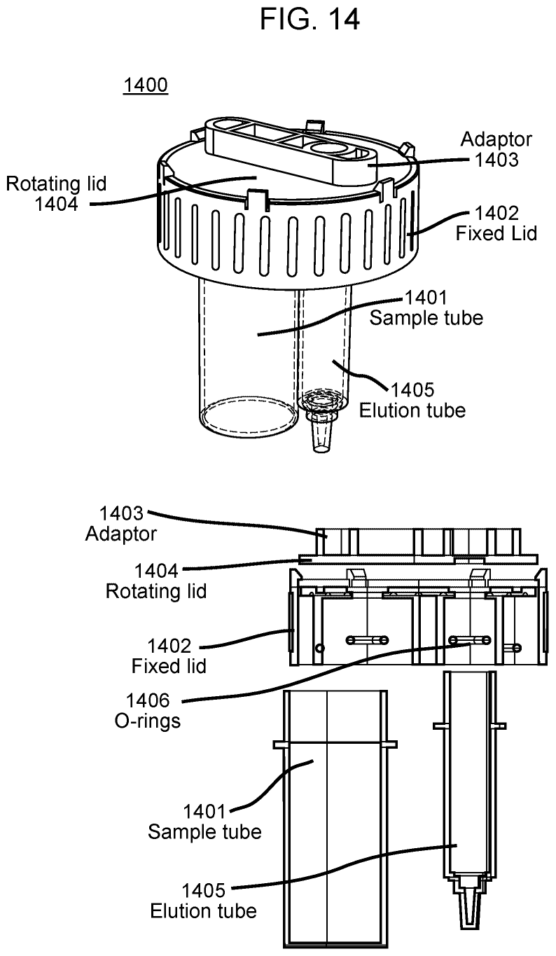

Examples of certain such embodiments is provided in FIGS. 14-16.

As shown in FIG. 14, in some embodiments, the device 1400 comprises a sample tube 1401 and an elution tube 1405. A fixed lid 1402 simultaneously engages with the sample tube and the elution tube. The engagement between the fixed lid and the sample and elution tubes may be sealed by o-rings 1406 which may be formed of a suitable flexible material, such as rubber.

The lid of the device further comprise a rotating lid 1404, which comprises adaptor 1403, which comprises a magnet. The rotating lid engages with the fixed lid such that rotating the rotating lid relative to the fixed lid allow the magnet in the rotating lid to engage with the sample tube in one position and with the elution tube in a second position.

During operation of the devices described in FIG. 14, a user can process a sample with a sample processing buffer and magnetic particles to allow capture of a target analyte onto the magnetic particles as described elsewhere in this disclosure.

Once the processing is completed, the rotating lid can be positioned so that the magnet in the adaptor engages with the sample tube. The sample tube may be shaken or even inverted so that the reagents within the sample tube, including the magnetic particles, interact with the magnet in the adaptor thereby causing the magnetic particles to be captured by the magnet.

A user can then rotate the rotating lid so that the adaptor is in the second position where the magnet in the adaptor engages with the elution tube. Thus, rotating of the rotating lid causes a sealed gas-phase transfer of magnetic particles from the sample tube to the elution tube.

Once the magnet in the adaptor is engaged with the elution tube, i.e., the magnetic particles are in the elution tube, the magnetic particles can be contacted with an elution buffer to cause release of the target analyte. Many options for eluting the target analyte are known in the art and use of such embodiments is within the purview of the disclosure.

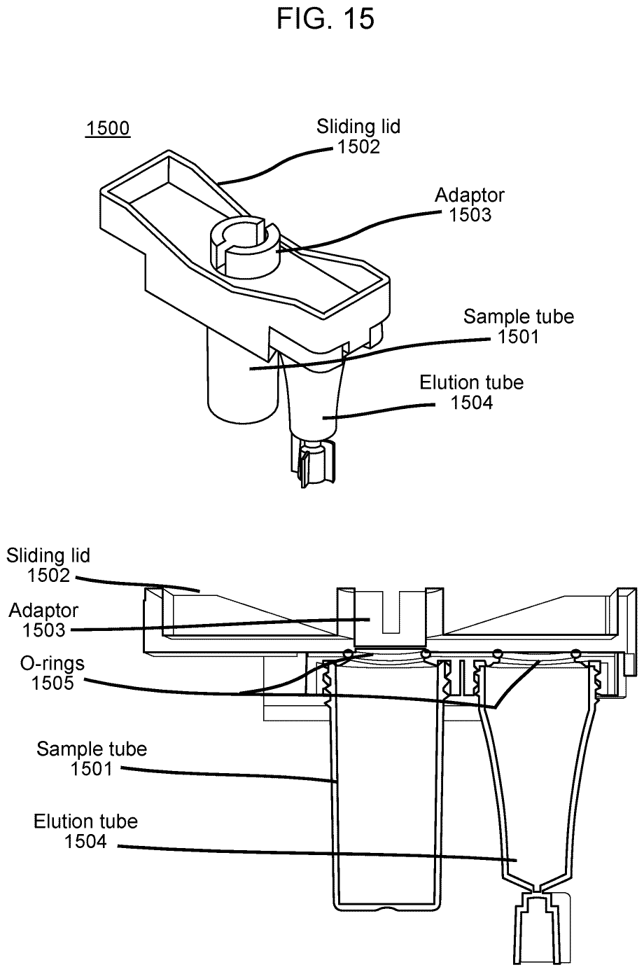

As shown in FIG. 15, in some embodiments, the device 1500 comprises a sample tube 1501 and an elution tube 1504. A sliding lid 1502 simultaneously engages with the sample tube and the elution tube. The engagement between the fixed lid and the sample and elution tubes may be sealed by rings 1505, which may be formed of a suitable flexible material, such as rubber.

The sliding lid of the device further comprise adaptor 1503, which comprises a magnet. The sliding lid engages with the sample tube and elution tube such that sliding the sliding lid allows the magnet in the adaptor to engage with the sample tube in one position and with the elution tube in a second position.

During operation of the devices described in FIG. 15, a user can process a sample with a sample processing buffer and magnetic particles to allow capture of a target analyte onto the magnetic particles as described elsewhere in this disclosure.

Once the processing is completed, the sliding lid can be positioned so that the magnet in the adaptor engages with the sample tube. The sample tube may be shaken or even inverted so that the reagents within the sample tube, including the magnetic particles, interact with the magnet in the adaptor thereby causing the magnetic particles to be captured by the magnet.

A user can then slide the sliding lid so that the adaptor is in the second position where the magnet in the adaptor engages with the elution tube. Thus, sliding of the sliding lid causes a sealed gas-phase transfer of magnetic particles from the sample tube to the elution tube.

Once the magnet in the adaptor is engaged with the elution tube, i.e., the magnetic particles are in the elution tube, the magnetic particles can be contacted with an elution buffer to cause release of the target analyte. Many options for eluting the target analyte are known in the art and use of such embodiments is within the purview of the disclosure.

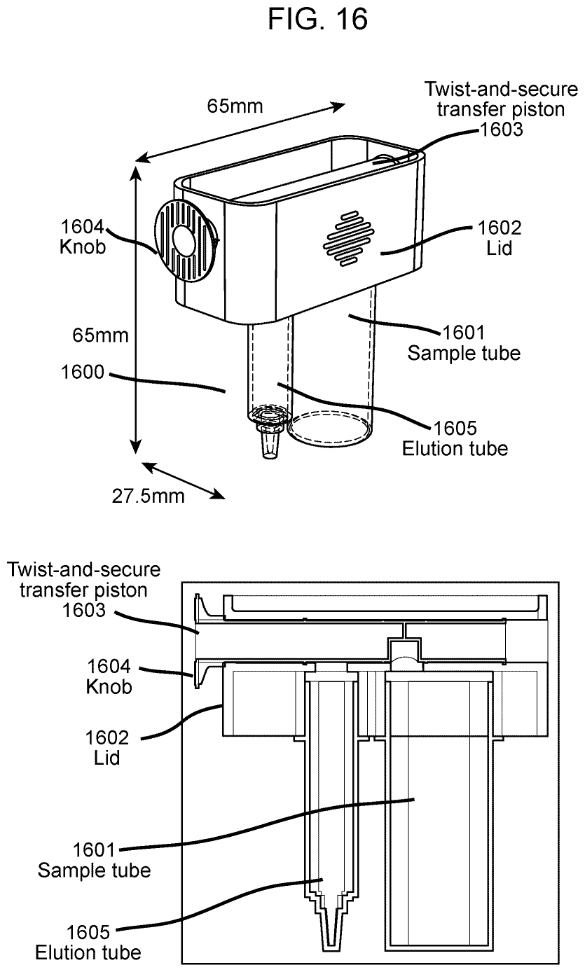

Moreover, as shown in FIG. 16, in some embodiments, the device 1600 comprises a sample tube 1601 and an elution tube 1604. A lid 1602 simultaneously engages with the sample tube and the elution tube. The engagement between the lid and the sample and elution tubes may be sealed by rings, which may be formed of a suitable flexible material, such as rubber.

The lid of the device further comprise a transfer piston 1603, which comprises a magnet. The transfer piston engages with the sample tube and elution tube such that moving the transfer piston allows the magnet in the sample piston to engage with the sample tube in one position and with the elution tube in a second position.

During operation of the devices described in FIG. 16, a user can process a sample with a sample processing buffer and magnetic particles to allow capture of a target analyte onto the magnetic particles as described elsewhere in this disclosure.

Once the processing is completed, the transfer piston can be positioned so that the magnet in the transfer piston engages with the sample tube. The sample tube may be shaken or even inverted so that the reagents within the sample tube, including the magnetic particles, interact with the magnet in the transfer piston thereby causing the magnetic particles to be captured by the magnet.

A user can then twist the knob 1604 so that the adaptor is in the second position where the magnet in the adaptor engages with the elution tube. Thus, twisting the knob causes a sealed gas-phase transfer of magnetic particles from the sample tube to the elution tube.

Once the magnet in the adaptor is engaged with the elution tube, i.e., the magnetic particles are in the elution tube, the magnetic particles can be contacted with an elution buffer to cause release of the target analyte. Many options for eluting the target analyte are known in the art and use of such embodiments is within the purview of the disclosure.

### Sample Preparation

The adaptor disclosed herein can be used for isolating an analyte of interest from a sample (positive isolation) or the removal of molecules other than the target of interest (negative isolation). The analyte of interest or target analyte and the sample may be as described in the preceding section.

In one embodiment, the method for using the adaptor disclosed herein for isolating an analyte of interest from a sample may include steps illustrated in FIG. 4 illustrates a sample preparation method that includes a step of transferring a sample (e.g., urine) to the tube, e.g., the tube 101 illustrated in FIGS. 1 and 2. The volume of the sample transferred to the tube may be about 0.5 ml-10 ml, e.g., at least 1 ml, at least 2 ml, at least 3 ml, at least 4 ml, at least 5 ml, or more.

Magnetic particles (also referred to a PMPs) functionalized to bind to the analyte of interest are added to the sample and the sample mixed with the magnetic particles. Mixing may involve stirring, inverting, shaking, and the like. The magnetic particles may be functionalized with an antibody that binds to the analyte. After addition of the PMPs, the tube may be covered with a cap and optionally inverted for mixing the PMPs. Alternatively, the sample may be mixed with the PMPs using a stirrer, such as, a swab. In certain embodiments, the tube may be attached to an opening of an adaptor as described herein (e.g., adaptor 100 or adaptor 200). For example, the tube 101 or 221 may be attached to opening 112 or 232 of the adaptor 100 or adaptor 200, respectively and inverted multiple times to mix the sample and the PMPs. In this embodiment, the adaptor serves as a cap and the orientation of the cylindrical cuff with reference to the cylindrical body is such that the opening in the surface of the cylindrical cuff faces an interior surface of the cylindrical body, thereby closing the opening. The cylindrical cuff occludes the interior of the cylindrical body thus preventing the sample from flowing to the second opening in the cylindrical body. This may be referred to as a first orientation of the cylindrical cuff. This first orientation may be denoted with an arrow on a lever attached to the cuff or the platform, which arrow may be parallel to the ground.

The PMPs may be incubated with the sample for a period of time sufficient to allow the analyte to bind to the PMPs, e.g., 1-30 minutes, e.g., at least 5 minutes, at least 10 minutes, at least 15 minutes, at least 20 minutes, or more.

The adaptor, with the opening in the cylindrical cuff oriented towards the first opening in the cylindrical body of the adaptor and the magnet oriented such that it is in fluidic communication with a fluid entering through the opening in the cylindrical cuff, is attached to an opening of the tube after the incubation. This step may involve uncapping both the tube and the first opening in the cylindrical body of the adaptor.

Alternatively, the adaptor is used as a cap and after incubation of the PMPs with the sample, the cylindrical cuff is rotated such that the opening in the cylindrical cuff faces the first opening in the cylindrical body of the adaptor thereby allowing the sample to flow into that cylindrical cuff and allow capture of PMPs by the magnet immobilized in the platform. This may be referred to as a second orientation of the cylindrical cuff. This second orientation may be denoted with an arrow on a lever attached to the cuff or the platform, which arrow may point downwards.

After the incubation step, the tube is inverted such that the sample and the PMPs contact the magnet. After a period of time sufficient to allow capture of the PMPs by the magnet, the tube may be inverted back such that the sample flows back into the tube and is no longer in the cylindrical cuff.

An elution tube that includes an elution buffer is attached to the second opening of the adaptor after or before the tube is inverted back. This step may also include removing a cap from the second opening of the adaptor and from an opening of the elution tube. Alternatively, the adaptor may not include a cap on the second opening and the method may involve rotating the cylindrical cuff to the first orientation and attaching the second opening to the elution tube. As noted in the preceding section, the elution tube may be in form of a conical structure with a orifice that may be covered with a cap.

After the elution tube is attached to the adaptor, the orientation of the cylindrical cuff is changed by actuating the rotation means such that the opening in the cylindrical cuff is in fluid communication with the solution in the elution tube. This may be referred to as a third orientation of the cylindrical cuff. This third orientation may be denoted with an arrow on a lever attached to the cuff or the platform, which arrow may point upwards. The magnet and the PMPs attached thereto may be contacted with the solution in the elution tube and after a period of time sufficient for elution of the target from the PMPs, the solution (e.g., elution buffer) containing any analyte may be dispensed onto a lateral flow assay device or other diagnostic device for detection of the analyte.

The lateral flow device may be a device known in the art for detecting the analyte. When the analyte is LAM Ag, the device for detection of the analyte may be DETERMINE™ TB LAM Ag.

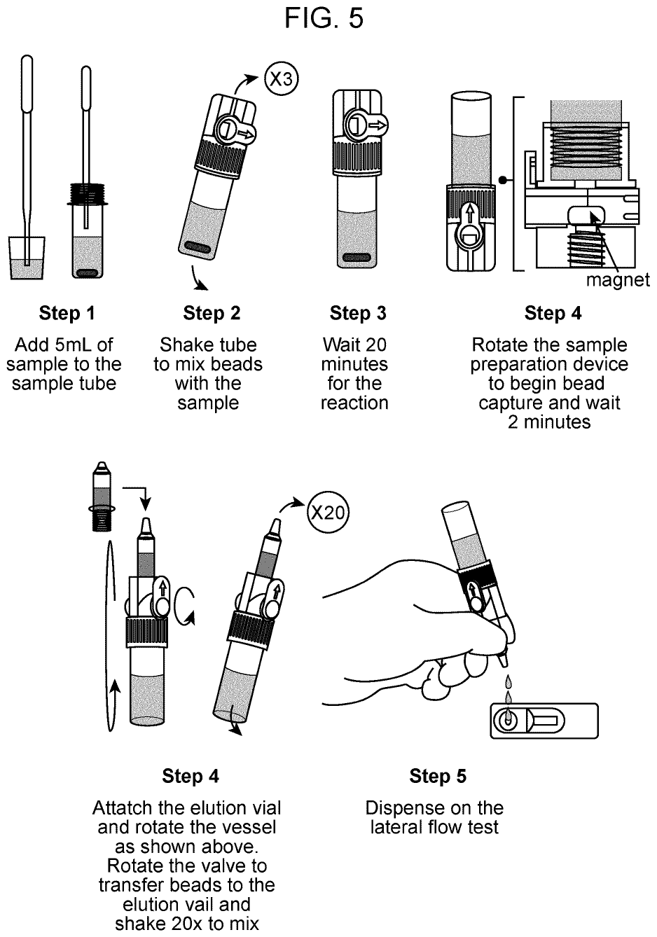

In one embodiment, the method for using the adaptor disclosed herein for isolating an analyte of interest from a sample may include steps illustrated in FIG. 5. A first step may include adding a sample to a sample tube and mixing it with PMPs. After a sufficient period of time, the PMPs are captured by a magnet present in an adaptor of the present disclosure by inverting the tube, as explained for FIG. 4. After the capture step, the tube is inverted back and an elution vial is attached to the adaptor. The orientation of the cylindrical cuff is changed by rotating it to bring the magnet in contact with the elution buffer present in the elution tube. After elution of the analyte, the elution buffer is dispensed onto a detection device.

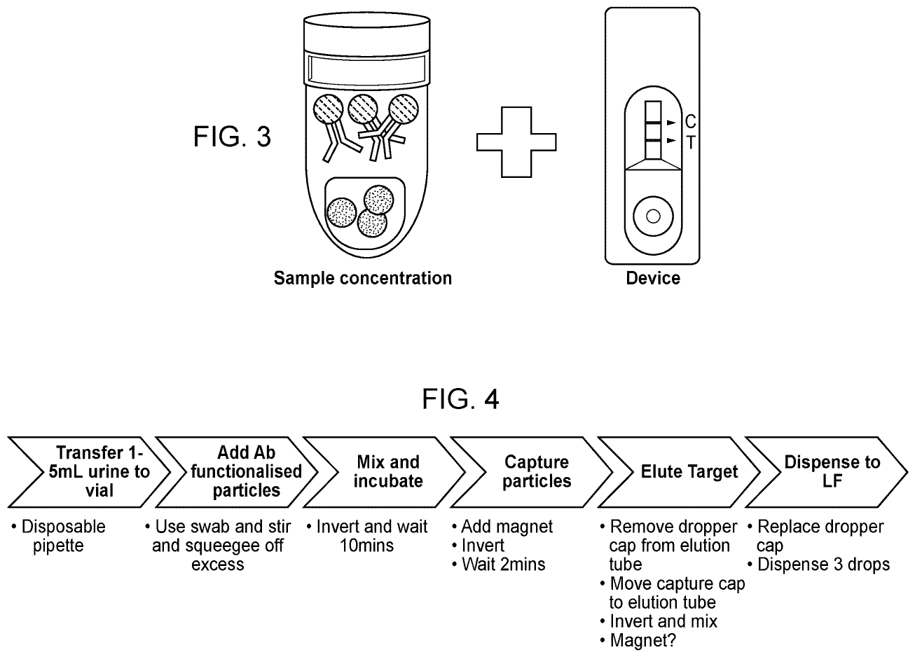

In further embodiments, the devices described in FIGS. 6-16 are used to isolate a target analyte. The operations of these devices and, thus, the methods of using these devices to isolate the target analytes are described above. Additional details described herein with respect to the devices of FIGS. 1 to 6 are also applicable to the devices of FIGS. 7-16 and such embodiments are within the purview of the disclosure.

Accordingly, the preceding merely illustrates the principles of the present disclosure. It will be appreciated that those skilled in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art and are to be construed as being without limitation to such specifically recited examples and conditions. Moreover, all statements herein reciting principles, aspects, and embodiments of the invention as well as specific examples thereof, are intended to encompass both structural and functional equivalents thereof. Additionally, it is intended that such equivalents include both currently known equivalents and equivalents developed in the future, i.e., any elements developed that perform the same function, regardless of structure. The scope of the present invention, therefore, is not intended to be limited to the exemplary embodiments shown and described herein. Rather, the scope and spirit of present invention is embodied by the appended claims.

We claim:

1. An adaptor for isolating an analyte of interest from a sample, the adaptor comprising:
a substantially cylindrical body comprising:
a first opening opposite a second opening, wherein the first and second openings are located along a longitudinal axis of the substantially cylindrical body;
an opening on a surface of the cylindrical body, the opening defining a space for slidable engagement with a cylindrical cuff,
wherein the cylindrical cuff is positionable within the cylindrical body such that a longitudinal axis of the cylindrical body is perpendicular to a longitudinal axis of the cylindrical cuff and the cylindrical cuff is rotatable with reference to the cylindrical body and wherein the cylindrical cuff is sized to occlude the interior of the cylindrical body to prevent flow of fluid from the first opening to the second opening,
a platform comprising a first region configured for immobilizing a magnet and a second region for rotating the platform,
wherein the platform is sized to fit inside the cylindrical cuff and rotate the cylindrical cuff upon rotation of the platform,
the cylindrical cuff comprising an opening located in a surface at a position between the two ends of the cylindrical cuff,
wherein the opening in the surface of the cylindrical cuff is in fluid communication with the magnet,
wherein the platform and the cylindrical cuff are rotatable such that in a:
first orientation, the opening in the surface of the cylindrical cuff faces an interior surface of the cylindrical body such that the opening is closed by the interior surface of the cylindrical body,
second orientation, the opening in the surface of the cylindrical cuff faces the first opening in the cylindrical body thereby allowing fluid entering through the first opening in the cylindrical body to flow into the cylindrical cuff, and
third orientation, the opening in the surface of the cylindrical cuff is aligned with the second opening in the cylindrical body thereby allowing fluid entering through the second opening in the cylindrical body to flow into the cylindrical cuff.

2. The adaptor of claim 1, wherein the platform comprises a means for rotating the platform, which means is located outside the cylindrical body, and is a lever.

3. The adaptor of claim 1, wherein the cylindrical cuff comprises a means for rotating the platform, which means is located outside the cylindrical body, and is a lever.

4. A system of components for isolating an analyte of interest from a sample, the system comprising the adaptor of any one of claims 1-3 and a vial for accepting the sample, wherein the first opening of the adaptor is attachable to an opening of the vial.

5. The system of claim 4, further comprising a tube for eluting the analyte, the tube comprising an opening for attaching to the second opening of the adaptor.

6. The system of claim 5, wherein the tube comprises an orifice opposite the opening for dispending the eluted analyte.

7. The system of any one of claims 4-6, further comprising magnetic particles functionalized to capture the analyte.

8. The system of any one of claims 4-7, further comprising a lateral flow device for detecting presence of the analyte.

9. The system of any one of claims 4-8, wherein the vial comprises a lysis solution.

10. The system of any one of claims 5-8, wherein the elution tube comprises an elution solution.

11. A device for isolating a target analyte from a sample, the device comprising:
an adaptor configured for mutually exclusively engaging with a first compartment and a second compartment, and the adaptor comprising a cap having a hole and a bead capture plunger,
a magnetic housing and plunger comprising a magnet,
wherein the bead capture plunger is a hollow elongated structure that is inserted into the first or the second compartment when the adaptor engages with the first or second compartment, and wherein the bead capture plunger also provides space for engaging with the magnet of the magnetic housing and plunger,
wherein the magnet of the magnetic housing and plunger captures magnetic particles that may be present in the first compartment or in the second compartment,
and wherein moving the adaptor from the first compartment to second compartment causes a sealed gas-phase transfer of magnetic particles from the first compartment to the second compartment.

12. The device of claim 11, wherein the adaptor engages with the first and/or the second compartments by a snap fit configuration, twist-cap configuration, or threaded screw-on configuration.

13. The device of claim 11 or 12, wherein the first compartment is a sample tube and the second compartment is an elution tube.

14. The device of claim 13, wherein the sample tube comprises a sample processing buffer and the elution tube comprises an elution buffer.

15. The device of claim 14, wherein the sample processing buffer comprises magnetic particles comprising a binding agent that specifically binds to the target analyte.

16. A device for isolating a target analyte from a sample, the device comprising:
an adaptor configured for engaging with a first compartment and a second compartment, wherein the first compartment is cylindrical tube and the second compartment is below the first compartment and is sealingly connected to the first compartment,
the adaptor comprising a bead capture plunger, wherein the bead capture plunger passes through the center of the first compartment and comprises a hollow longitudinal center that provides a space for accommodating a magnet from a magnet housing and plunger, and wherein the bead capture plunger comprises a bead capture area,
wherein the magnet housing and the plunger is configured to pass through the bead capture plunger and capture magnetic particles that may be present in the first compartment in the bead capture area of the bead capture plunger, and
the magnetic housing and plunger further configured to piercably move from the first compartment into the sealingly connected second compartment thereby causing a sealed gas-phase transfer of magnetic particles from the first compartment to the second compartment.

17. The device of claim 16, wherein the adaptor engages with the first compartment by a snap fit configuration, twist-cap configuration, or threaded screw-on configuration.

18. The device of claim 16 or 17, wherein the first compartment is a sample tube and the second compartment is an elution tube.

19. The device of claim 18, wherein the sample tube comprises a sample processing buffer and the elution tube comprises an elution buffer.

20. The device of claim 19, wherein the sample processing buffer comprises magnetic particles comprising a binding agent that specifically binds to the target analyte.

21. A device for isolating a target analyte from a sample, the device comprising:
a lid that simultaneously engages with a first compartment and a second compartment,
the lid comprising an adaptor comprising a removable magnet that can be positioned in a first position, where the magnet captures magnetic particles that may be present in the first compartment or in a second position, where the magnet captures magnetic particles that may be present in the second compartment,
and wherein the lid comprises means for moving the adaptor from the first position to the second position to cause a sealed gas-phase transfer of magnetic particles from the first compartment to the second compartment.

22. The device of claim 21, wherein the means for moving the adaptor from the first position to the second position comprises a rotating lid upon which the adaptor is mounted and wherein rotating the rotating lid causes the adaptor to move from the first position to the second position.

23. The device of claim 21, wherein the means for moving the adaptor from the first position to the second position comprises a sliding lid upon which the adaptor is mounted and wherein sliding the sliding lid causes the adaptor to move from the first position to the second position.

24. The device of claim 21, wherein the means for moving the adaptor from the first position to the second position comprises a transfer piston mounted on the lid and comprising the adaptor and laterally moving the transfer piston causes the adaptor to move from the first position to the second position.

25. The device of any one of claims 21 to 24, wherein the lid engages with the first compartment and/or the second compartment by a snap fit configuration, twist-cap configuration, or threaded screw-on configuration.

26. The device of any one of claims 21 to 25, wherein the first compartment is a sample tube and the second compartment is an elution tube.

27. The device of claim 26, wherein the sample tube comprises a sample processing buffer and the elution tube comprises an elution buffer.

28. The device of claim 27, wherein the sample processing buffer comprises magnetic particles comprising a binding agent that specifically binds to the target analyte.

29. A method of isolating a target analyte from a sample, the method comprising processing the sample in a device of any one of claims 1 to 28.
